(19) United States
(12) Patent Application Publication
(10) Pub. No.: US 2026/0262152 A1
(43) Pub. Date: Sep. 3, 2026

(54) Face-Tracking Follow-Spot System

(71) Applicant: WiSys Technology Foundation, Inc., Madison, WI (US)

(72) Inventors: Valliammai Arunachlam, LaCrosse, WI (US); Dlpankar Mltra, LaCrosse, WI (US); Doug Wilken, Onalaska, WI (US)

(21) Appl. No.: 19/554,270

(22) Filed: Mar. 2, 2026

Related U.S. Application Data
(60) Provisional application No. 63/764,970, filed on Feb. 28, 2025.

(51) Int. Cl. H05B 47/125; G06V 20/52; G06V 40/16

(52) U.S. Cl. CPC H05B 47/125; G06V 20/52; G06V 40/161

(57) ABSTRACT

A face-tracking follow-spot system is provided that automatically directs light toward an individual as that individual moves about a stage or other area. The system may include a movable spotlight unit, an imaging device such as a video camera, and a control system. The control system receives signals from the video camera that correspond to location of an individual being illuminated, identifies the individual's location, and commands movement of the spotlight unit to direct its focused beam of light toward the individual. Evaluating the individual's location may be performed non-intrusively or without worn targets, tags, or other markers, such as by way of facial recognition methodologies.

### CROSS REFERENCE TO RELATED APPLICATION

This application claims the benefit of U.S. provisional application 63/764,970 filed Feb. 28, 2025, and hereby incorporated by reference in its entirety.

### FIELD OF THE INVENTION

The present invention relates to lighting systems and, in particular, to an automatic follow-spot system directing light to an individual as that individual moves about a stage or area.

### BACKGROUND OF THE INVENTION

A follow-spot is a high-intensity spotlight, finding common use in theatrical productions where it is used to provide focused lighting on one or more individuals such as actors, performers, or other individuals on a stage or set. The follow-spot is pivotable, allowing an operator to maneuver the follow-spot during a performance to track the individual as they may move. Traditionally the follow-spot operator is located on an elevated platform to command a full view of the stage or area. Currently, a servo-controlled spotlight may be manually operated remotely by a follow-spot operator viewing the stage via a camera and video monitoring system. Current auto-tracking systems require the individual to wear an external marker, such as a QR code or other high-contract tracking target, a dedicated tracking beacon, or fob in order for the auto-tracking feature to function.

Follow-spots can be costly to implement, requiring a trained individual who can manage the follow-spot during the entire performance. Multiple follow-spots require additional individuals. Smooth follow-spot positioning is a learned skill and can be challenging, particularly when there is rapid motion, often requiring the operator to follow stage directions to anticipate such motion.

Follow-spot auto-tracking systems present additional challenges since these systems rely on the integrity of the external markers and/or the line-of-sight visibility of the markers with system sensors. These challenges can be further complicated during rapid movement of the individuals and their worn external markers.

### SUMMARY OF THE INVENTION

The present inventors have recognized that for many important theatrical and presentation purposes, the follow-spot target will be a person presenting his or her face in a consistent direction, for example, toward the follow-spot and audience position. This presents the possibility of using non-intrusive (devoid of tags or external targets) feature recognition such as computerized facial recognition to automatically track the follow-spot to an individual such as actors, performers, or other individuals. Computerized tracking through face recognition eliminates the need for special tracking hardware and allows high-speed response for smooth control even in highly dynamic and unpredictable situations. Facial recognition further avoids false targeting of stage objects or set pieces. Further, a single servo-controlled lighting instrument may be programmed to auto-track multiple individuals in series via a user selectable control interface. Multiple servo-controlled lighting instruments may be programmed to simultaneously auto-track a single individual or multiple servo-controlled lighting instruments may be independently assigned to auto-track multiple individuals via a user selectable control interface.

According to one aspect of the invention, the system applies object recognition to fully automate dynamic tracking of an individual.

According to another aspect of the invention, the system automatically directs light toward an individual as that individual moves about a stage or other area. The system may include a movable spotlight unit, an imaging device such as a video camera, and a control system. The control system may receive signals from the video camera that correspond to location of an individual being illuminated. The control system may identify the individual's location and commands movement of the spotlight to direct its focused beam of light toward the individual. Evaluating the individual's location may be performed by the control system non-intrusively or without worn targets, tags, or other markers, such as by way of facial recognition methodologies.

It is thus a feature of at least one embodiment of the invention to provide a follow-spot system that automatically tracks an individual without requiring external or synthetic markers or other user-worn applied tags or devices.

These particular objects and advantages may apply to only some embodiments falling within the claims and thus do not define the scope of the invention.

### BRIEF DESCRIPTION OF THE DRAWINGS

FIG. 1 is a schematic representation of a face-tracking follow-spot system per the present invention including a servo driven spotlight, camera, and control system; and

FIG. 2 is a flowchart of a program executed by the control system of FIG. 1.

### DETAILED DESCRIPTION OF THE PREFERRED EMBODIMENT

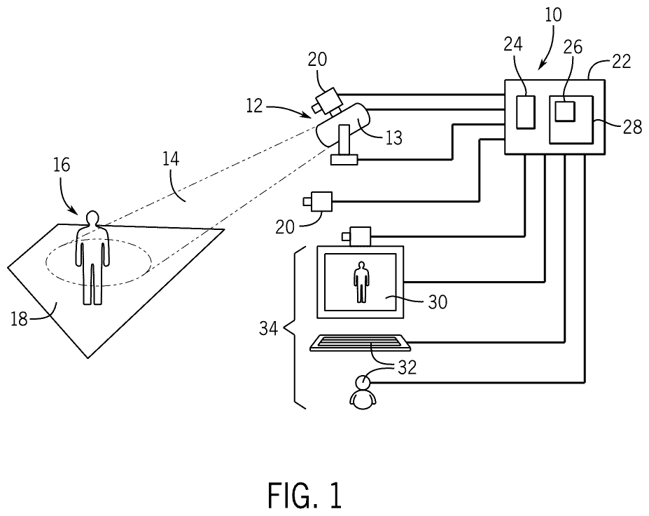

Referring now to FIG. 1, a follow-spot system 10 according to one embodiment of the present invention may provide for a spotlight unit 12 including a spotlight 13, the latter projecting a focused beam 14 toward an individual 16 on a stage 18 or other venue, for example, where photography or video is required. Spotlight 13 is may be movably mounted to a support structure with a spotlight drive, typically provided in spotlight unit 12. The spotlight drive is typically arranged between the spotlight 13 and its support structure to move spotlight 13 in response to movement commands.

The spotlight unit 12, in one embodiment, may be a commercially available servo-driven spotlight having a servo-based spotlight drive providing pan, tilt, and zoom features which permit the focused beam 14 to be selectively and flexibly maneuvered and focused in response to operator or system-issued commands. An example spotlight unit 12 suitable for use with the present invention is the iESPRITE® spotlight commercially available from Robe Show Lighting sro providing a light output of 55,000 lumens using a bank of LEDs and providing a pan angle of 540° and a tilt angle of 265°. Other commercially available servo-driven lighting instruments may also be utilized.

Each of the features of the spotlight unit 12, including the pan, tilt angle, and zoom, as well as brightness and color effects, may be controlled using the DMX512 standard for digital communication networks commonly used to control lighting and effects. DMX512 uses a unidirectional EIA-485 (RS-485) differential signaling at its physical layer, in conjunction with a variable-size, packet-based communication protocol. The DMX standard is published by the Entertainment Services and Technology Association (ESTA). The invention contemplates that other control protocols may also be used.

An imaging device such as an electronic digital video camera 20 is positioned to monitor an area such as stage 18 and provide a full view of the individual 16 over the area of the stage 18. In various embodiments, the camera 20 may be movable during use, such as mounted on the spotlight 13 to move with the angle of the beam 14/In other implementations, camera 20 is non-movably mounted to a support, for example, near the follow-spot system 10 but stationary upon a support structure at a constant location to provide a view of the full area of the stage 18, or at another arbitrary stationary position, for example, near an operator. The camera is configured to capture video and may transmit or output a digital video signal, for example, wirelessly or into a wired ethernet connection. Camera 20 may be implemented in a camera system having a camera array with multiple cameras 20 facing the monitored or performance area such as stage 18. The different cameras 20 of the camera array may be spaced sufficiently far from each other and/or at sufficiently different angles to provide multiple simultaneous different views of the monitored area such as stage 18 to reduce instances of the individual (e.g., including the individual's face) not being in a viewable area of at least one camera 20 in the camera array.

The camera 20 and the spotlight unit 12 may communicate with a central controller 22 of a control system, for example, having one or more processors 24 executing a stored program 26 held in computer memory 28. The central controller 22 may also communicate with a display 30 displaying an image acquired by the camera 20 and various overlaid computer-generated symbols associated with targeting of the spotlight unit 12 as will be described. The central controller 22 may also receive input signals from one or more user controls 32 such as a keyboard, joystick, trackball, and the like, for interacting with the controller 22 and images on the display 30. In some cases, the camera may be mounted on the display 30 to provide an image of the stage 18 from the vantage point of the operator.

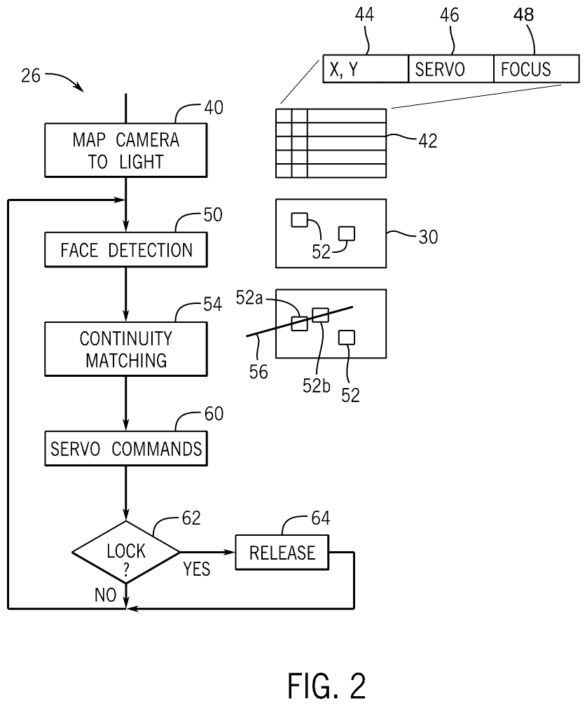

Referring now to FIG. 2, the program 26 may execute by first undertaking a calibration as indicated by process block 40. During this calibration process, the controller 22 receives input from the camera 20 and from the user (through the interface 34 of the display 30 and user controls 32 shown in FIG. 1) to provide a mapping relating locations on the stage 18 to corresponding pixels on the display 30 and servo angles on the spotlight unit 12. This mapping may be stored in a logical table 42 linking pixel coordinates 44 of the display 30 with servo pan and tilt values 46 indicating a positioning of the spotlight 13 when centered on the pixel coordinates. The logical table 42 may optionally store a desired focus value 48 in light intensity (not shown) of the spotlight 13 for those coordinates 44.

In one embodiment, the calibration is conducted by instructing the user to place a cursor at various locations on the visible area of the stage 18 as viewed in the display 30 using the user control 32 and then manually guiding the spotlight 13 to those same locations by controlling the spotlight unit 12 manually through the DMX connection. In an alternative embodiment, this calibration may be automated by a scanning of the spotlight 13 of the spotlight unit 12 through the pan and tilt range and identifying a center of the focused beam 14 on the stage 18 as represented in the display. This can be done automatically by image recognition of center of the display spotlight beam has illuminating the stage 18. This logical table 42 will later be used to process the image on the display 30 to automatically generate servo commands to control the spotlight unit 12 and to allow manual control of the spotlight unit 12 by selecting a point on the display 30.

In an alternate embodiment, the calibration step of process block 40 is not necessary other than aligning the camera 20 with the beam 14. Control of the spotlight unit 12 may be based on a deviation of a desired target from the center of the image displayed on the display 30 such as will also represent a center of the beam 14.

In both above cases, during operation of the follow-spot system 10, at process block 50, an image captured by the camera 20 will be processed using non-intrusive feature recognition (that does not require tags or external targets) evaluation, such as computerized face recognition that automatically detects facial features and/or characteristics to identify the coordinates 52 on the display 30 (and hence with respect to the image displayed on the screen) where human faces appear. The coordinates 52 may, for example, be described by superimposed bounding boxes on the display 30 showing the area of the face. In one embodiment, the facial recognition system may make use of the Haar Cascade Algorithm generally known in the art or machine learning systems may be trained on faces, for example, using Open CV for object recognition.

Referring now to process block 54, in the case where multiple locations of faces are identified, the human operator may select one location 52a for tracking by the follow-spot system 10. With multiple iterations of the program, successive frames of video may be analyzed each providing new coordinates 52b which must be matched to the initially identified location 52a to provide the following spotlight unit 12 with instructions to relocate the beam 14 to the new matched location 52b. This matching of earlier coordinates 52a with later coordinates 52b may use any of a variety of techniques including linking coordinates 52a and 52b in previous and subsequent iterations of process block 54 according to proximity or according to an extrapolated trajectory 56 of the last several previous coordinates 52 (that is, selecting the location 52b in the latest iteration that is closest to the trajectory 56 as extrapolated). In this way a current location 52b is always identified in favor of other possible coordinates 52′ associated with possibly different individuals. In an alternative embodiment, a machine learning system may be programmed to recognize individuals as well as faces allowing this identification of specific individuals to be used to link coordinates 52a to later coordinates 52b in successive iterations of the program according to individual identity. The identification of specific individuals may also be implemented in the face recognition algorithm.

At succeeding process block 60, the current location 52b is used to provide servo signals to the spotlight unit 12 to align the spotlight beam 14 with the new location 52b using the mapping table 42. When the camera 20 is mounted directly on the spotlight 13, the control signal sent to the spotlight unit 12 may simply reflect a difference between the location 52b and the center of the image in the display 30.

At decision block 62, if a null condition for the individual's location or a no current location 52b is identified, for example, when an individual such as an actor leaves the stage or the actor's face is obscured for more than a predetermined time period, the program 26 may identify a potential lost-target event. The system may evaluate the potential lost-target event, for example, with respect to a lost-target event time period threshold to confirm presence or existence of a lost-target event. Upon determining or confirming the existence of the lost-target event, the system may command performance of a light-locking event and enter a lock state per process block 64 where the spotlight 13 (FIG. 1) may be held in its current location and is dimmed and the system user or operator is notified with a lost-target event notification, typically through interface 34 (FIG. 1). The lost-target event time period threshold value may be between 0.5 second to 5 seconds, such as about 0.5 second, or 1.0 second, or 1.5 seconds, or 2.0 seconds, or 2.5 seconds, to 3.0 seconds, or 3.5 seconds, or 4.0 seconds, or 4.5 seconds, or 5.0 seconds. In one implementation, the lost-target event time threshold value is 2.0 seconds at which time system 10 sends the lost-target event notification to the operator. The operator of system 10 may then identify a different location 52, for example, when the actor returns to the stage or reappears, or a new actor requires the spotlight 13. This may include the operator of system 10 selecting the actor's location through interface 34 (FIG. 1) to drive spotlight unit 12 (FIG. 1) to that location until camera 20 (FIG. 1) (re) identifies the actor. In some implementations, this may include an activate request from the operator and a confirmation input that system 10 is properly identifying and tracking the actor as part of an unlocking. After unlocking per process block 64 or when there is no lock, the process of process blocks 50, 54, 60, and 62 is repeated.

Certain terminology is used herein for purposes of reference only, and thus is not intended to be limiting. For example, terms such as “upper,” “lower,” “above,” and “below,” refer to directions in the drawings to which reference is made. Terms such as “front,” “back,” “rear,” “bottom,” and “side,” describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first,” “second,” and other such numerical terms referring to structures do not imply a sequence or order unless clearly indicated by the context.

When introducing elements or features of the present disclosure and the exemplary embodiments, the articles “a,” “an,” “the,” and “said,” are intended to mean that there are one or more of such elements or features. The terms “comprising”, “including,” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

References to “a controller,” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What we claim is:

1. A face-tracking follow-spot system, comprising:
a spotlight unit including:
a spotlight movably mounted with respect to a support structure to direct a light toward an area;
a spotlight drive mounted between the support structure and the spotlight and configured to selectively move the spotlight for illuminating an individual in the area;
an imaging device facing the area and configured to capture video of the area and transmit a video signal;
a control system configured to:
receive the video signal;
apply a non-intrusive feature recognition evaluation to the captured video from the video signal to identify a location of the individual in the area; and
command the spotlight drive to drive movement of the spotlight to illuminate the individual at the identified location.

2. The system of claim 1, wherein:
the non-intrusive feature recognition evaluation includes facial recognition; and
the control system commands driving movement of the spotlight as a function of automatically detected facial characteristics.

3. The system of claim 2, wherein the imaging device is a video camera communicating with the control system.

4. The system of claim 3, wherein the video camera is configured to move during use while capturing video of the area.

5. The system of claim 4, wherein the video camera is mounted to and moves in unison with the spotlight.

6. The system of claim 3, wherein the video camera is non-movably mounted to a support structure.

7. The system of claim 6, wherein the video camera is one of multiple cameras in a camera array that are spaced from each other with each camera facing the area.

8. The system of claim 3, wherein the control system is configured to:
identify a potential lost-target event in which a null condition is identified for individual's location as a potential lost-target event;
evaluate the potential lost-target event with respect to a lost-target event time period threshold; and
upon confirming existence of a lost-target event:
commanding a light-locking event.

9. The system of claim 8, wherein the light-locking event includes:
holding the spot light in its current location;
dimming the spotlight; and
notifying an operator of the system of the lost-target event.

10. A method of automatically tracking an individual with a spotlight, the method comprising:
monitoring an area with an individual with an imaging device that captures video of an individual in the monitored area;
transmitting a video signal that corresponds to the monitored area from the imaging device to a control system;
with the control system:
applying a non-intrusive feature recognition evaluation to the captured video from the video signal to identify a location of the individual within the monitored area;
commanding driving of a spotlight to the identified location;
illuminating the individual with the spotlight at the identified location.

11. The method of claim 10, further comprising:
performing a facial recognition evaluation as the non-intrusive feature recognition evaluation.

12. The method of claim 11, further comprising:
moving the imaging device in unison with the spotlight while monitoring the monitored area.

13. The method of claim 11, further comprising:
maintaining the imaging device in a constant location while monitoring the monitored area.

14. The method of claim 13, wherein the imaging device is one of multiple video cameras in a camera array and the method further comprises:
simultaneously capturing video of the monitored area from multiple locations;
transmitting multiple video signals from the multiple video cameras that correspond to the captured video from the multiple locations; and
commanding driving of a spotlight to the identified location based on at least one of the multiple video signals.

15. The method of claim 11, the method further comprising:
identifying a potential lost-target event in which a null condition is identified for individual's location as a potential lost-target event;
evaluating the potential lost-target event with respect to a lost-target event time period threshold.

16. The method of claim 15, the method further comprising:
commanding a light-locking event upon confirming existence of a lost-target event.

17. The method of claim 15, wherein the light-locking event includes:
holding the spot light in its current location;
dimming the spotlight; and
notifying an operator of the system of the lost-target event.
